(19) United States
(12) Patent Application Publication
(10) Pub. No.: US 2010/0030786 A1
(43) Pub. Date: Feb. 4, 2010

(54) SYSTEM AND METHOD FOR COLLECTING DATA AND EVIDENCE

(75) Inventor: James T. McConnell, North Richland Hills, TX (US)

Correspondence Address: VERIZON;PATENT MANAGEMENT GROUP, 1320 North Court House Road, 9th Floor, ARLINGTON, VA, 22201-2909, US

(73) Assignee: Verizon Corporate Services Group Inc., Basking Ridge, NJ (US)

(21) Appl. No.: 12/181,587

(22) Filed: Jul. 29, 2008

(51) Int. Cl. G06F 7/08; G06F 15/16; G06F 17/30

(52) U.S. Cl. 707/10; 707/E17.031; 707/E17.032; 707/E17.055

(57) ABSTRACT

A system and method for collecting evidentiary information from the one or more evidence systems associated with the evidence systems network, storing the evidentiary information collected from the one or more evidence systems associated with the evidence systems network, processing the evidentiary information collected from the one or more evidence systems associated with the evidence systems network in a chronological order, outputting result of the processed evidentiary information collected from the one or more evidence systems associated with the evidence systems network.

### BACKGROUND INFORMATION

In a criminal or policy violation investigation, there may be many logical and/or physical environments that provide evidentially information (e.g., any type of data and/or evidence) as to who, what, when, where, and how the crime took place. Often, crime scene reconstruction may be necessary in order to facilitate the criminal or policy violation investigation. In crime scene reconstruction visuals, the renderings may be either two dimensional (i.e., flat drawings) or may be limited in the aspect of depth (e.g., pictures). Also, time (e.g., timeline chart) associated with a crime may be a component of the crime scene reconstruction. In practice, crime scene reconstructions may require extensive efforts to correlate visual information and/or time information. For example, most crime scene reconstructions may require manual review of information from a variety of evidence systems, such as system access logs, call data records, security badge logs, and/or closed-circuit television (CCTV) footage. Moreover, investigators may find that a variety of evidence may be provided by the various evidence systems located at disparate places. As a result, current crime scene reconstructions may not allow for an investigator to easily identify a suspect for the crime. More specifically, current crime scene reconstructions do not allow the investigator to piece together the available information from various evidence systems to determine the suspect for the crime.

### BRIEF DESCRIPTION OF THE DRAWINGS

In order to facilitate a full understanding of the exemplary embodiments, reference is now made to the appended drawings. These drawings should not be construed as limiting, but are intended to be exemplary only.

FIG. 1 illustrates a high level schematic of a data and evidence collection system in accordance with an exemplary embodiment;

FIG. 2 illustrates a detailed exemplary system for collecting evidentiary information from one or more evidence systems in accordance with an exemplary embodiment;

FIGS. 3A-3E illustrate an exemplary timeline provided by a data and evidence collection system in accordance with an exemplary embodiment; and

FIG. 4 is a flow diagram of a method for collecting data and evidence in accordance with an exemplary embodiment.

These and other embodiments and advantages will become apparent from the following detailed description, taken in conjunction with the accompanying drawings, illustrating by way of example the principles of the various exemplary embodiments.

### DETAILED DESCRIPTION OF EMBODIMENTS

A system and method in accordance with exemplary embodiments may enable user (e.g., an investigator) to query one or more evidence systems based at least in part on a user input. Also, the system and method may collect evidentiary information from the one or more evidence systems based at least in part on the user input. Further, the system and method may integrate the evidentiary information from one or more evidence systems and/or construct a timeline based at least in part on the integrated evidentiary information. Additionally, the system and method may provide one or more display windows for displaying evidentiary information from each of the one or more evidence systems. Moreover, the system and method may provide a toolbar to allow the user to select evidentiary information at a desired time along the timeline.

The description below describes servers, computers, evidence systems, client devices, and other computing devices that may include one or more modules, some of which are explicitly depicted, others of which are not. As used herein, the term “module” may be understood to refer to executable software, firmware, hardware, and/or various combinations thereof. It is noted that the modules are exemplary. The modules may be combined, integrated, separated, and/or duplicated to support various applications. Also, a function described herein as being performed at a particular module may be performed at one or more other modules and/or by one or more other devices instead of or in addition to the function performed at the particular module. Further, the modules may be implemented across multiple devices and/or other components local or remote to one another. Additionally, the modules may be moved from one device and added to another device, and/or may be included in both devices. It is further noted that the software described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of storing software, and/or combinations thereof. Moreover, the figures illustrate various components (e.g., servers, computers, etc.) separately. The functions described as being performed at various components may be performed at other components, and the various components may be combined and/or separated. Other modifications also may be made.

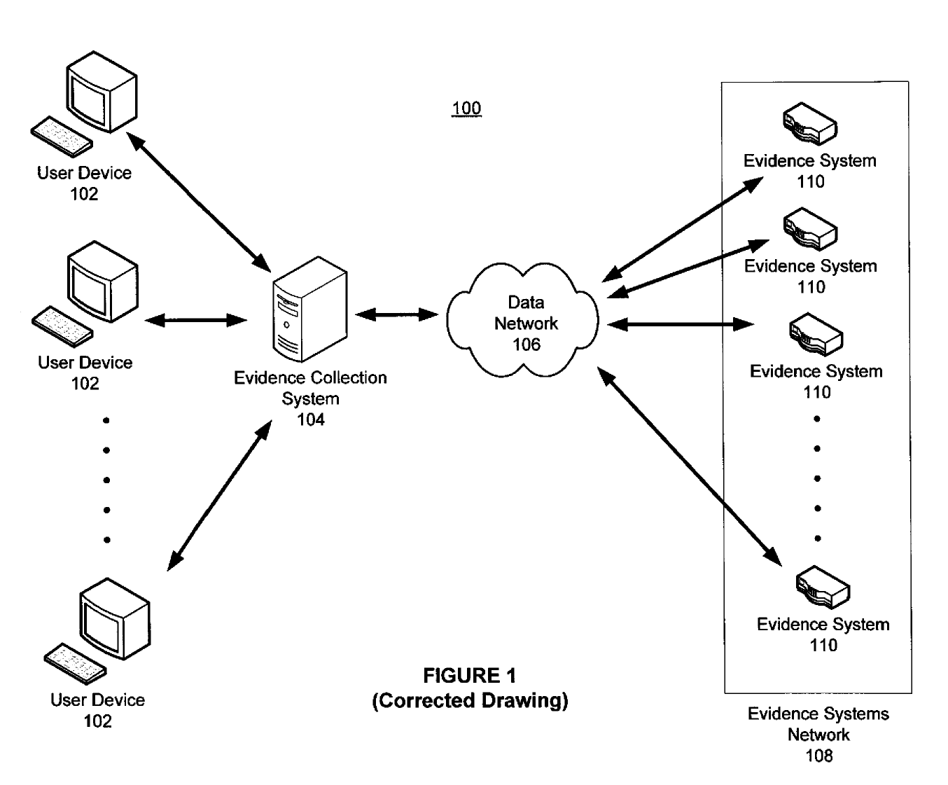

FIG. 1 illustrates an exemplary system 100 for collecting evidentiary information in accordance with an exemplary embodiment. The system 100 may collect evidentiary information from one or more evidence systems for a user investigating a policy violation and/or a criminal violation. It should be appreciated that as used herein, a “user” may refer to police, investigators, security personnel, and/or other authorized personnel responsible for investigating the policy violation and/or the criminal violation. Also, it should be appreciated that as used herein, a “policy violation” may refer to improper use (e.g., non-work related) of an electronic network and/or electronic devices as indicated by a business organization. Also, a “policy violation” may refer to any unauthorized use, attempt, or successful entry into a digital, computerized, or automated system, or network, or other physical or electronic asset, and/or other unauthorized entry into a restricted area. Further, it should be appreciated that as used herein, a “criminal violation” may refer to any offense or wrongdoings according to the criminal code of a jurisdiction (e.g., state jurisdiction and/or federal jurisdiction).

As illustrated in FIG. 1, system 100 may include one or more user devices 102 which may interact with one or more evidence systems 110 via an evidence collection system 104 and/or a data network 106. The one or more evidence systems 110 may be coupled to each other to form an evidence systems network 108. In an exemplary embodiment, a user may be associated with the one or more user devices 102 and the user may submit one or more queries/requests to the evidence collection system 104 via the one or more user devices 102. The evidence collection system 104 may access the one or more evidence systems 110 via the data network 106 and collect evidentiary information based at least in part on one or more queries/requests from the one or more user devices 102. The evidence collection system 104 may process the collected evidentiary information in a chronological order and/or may present the processed evidentiary information to the user via the one or more user devices 102.

The one or more user devices 102 may be a computer, a personal computer, a laptop, a cellular communication device, a global positioning system (GPS), a workstation, a mobile device, a phone, a handheld PC, a personal digital assistant (PDA), a thin system, a fat system, a network appliance, an Internet browser, a paging system, an alert device, a television, an interactive television, a receiver, a tuner, a high definition (HD) television, a HD receiver, a video-on-demand (VOD) system, and/or other any other device that may allow a user to communicate with the evidence collection system 104 via one or more networks (not shown) as known in the art. A user associated with the one or more user devices 102 may interactively submit one or more queries/requests to collect evidentiary information from the one or more evidence systems 110. Also, the user may view various evidentiary information collected from the one or more evidence systems 110 within the evidence systems network 108 via the one or more user devices 102.

The evidence collection system 104 may include one or more servers. For example, the evidence collection system 104 may include a UNIX based servers, Windows 2000 Server, Microsoft IIS server, Apache HTTP server, API server, Java sever, Java Servlet API server, ASP server, PHP server, HTTP server, Mac OS X server, Oracle server, IP server, and/or other independent server to collect evidentiary information from the one or more evidence systems 110. Also, the one or more servers of the evidence collection system 104 may be located at one location or located remotely from each other.

The data network 106 may be coupled to the evidence systems network 108. The data network 106 may be a wireless network, a wired network or any combination of wireless network and wired network. For example, the data network 106 may include, without limitation, Internet network, satellite network (e.g., operating in Band C, Band Ku and/or Band Ka), wireless LAN, Global System for Mobile Communication (GSM), Personal Communication Service (PCS), Personal Area Network (PAN), D-AMPS, Wi-Fi, Fixed Wireless Data, satellite network, IEEE 802.11a, 802.11b, 802.15.1, 802.11n and 802.11g and/or any other wireless network for transmitting a signal. In addition, the data network 106 may include, without limitation, telephone line, fiber optics, IEEE Ethernet 802.3, wide area network (WAN), local area network (LAN), and/or global network such as the Internet, Also, the data network 106 may enable, an Internet network, a wireless communication network, a cellular network, an Intranet, or the like, or any combination thereof. The data network 106 may further include one, or any number of the exemplary types of networks mentioned above operating as a stand-alone network or in cooperation with each other.

The evidence systems network 108 may be a network of evidence systems 110 communicatively coupled to each other. The network of evidence systems 110 may be communicatively coupled to each other in a data network similar to the data network 106, as described above. In an exemplary embodiment, the evidence systems network 108 may include one or more evidence systems 110. The one or more evidence systems 110 may include closed-circuit television (CCTV) evidence systems, security access control evidence systems, network access control evidence systems, telephone evidence systems, and/or other evidence systems that may provide evidentiary information queried by a user. Also, the evidence systems network 108 may include one or more independent evidence systems 110 (e.g., uncoupled to each other). For example, each independent evidence systems 10 within the evidence systems network 108 may be located remotely from each other and each independently coupled to the evidence collection system 104.

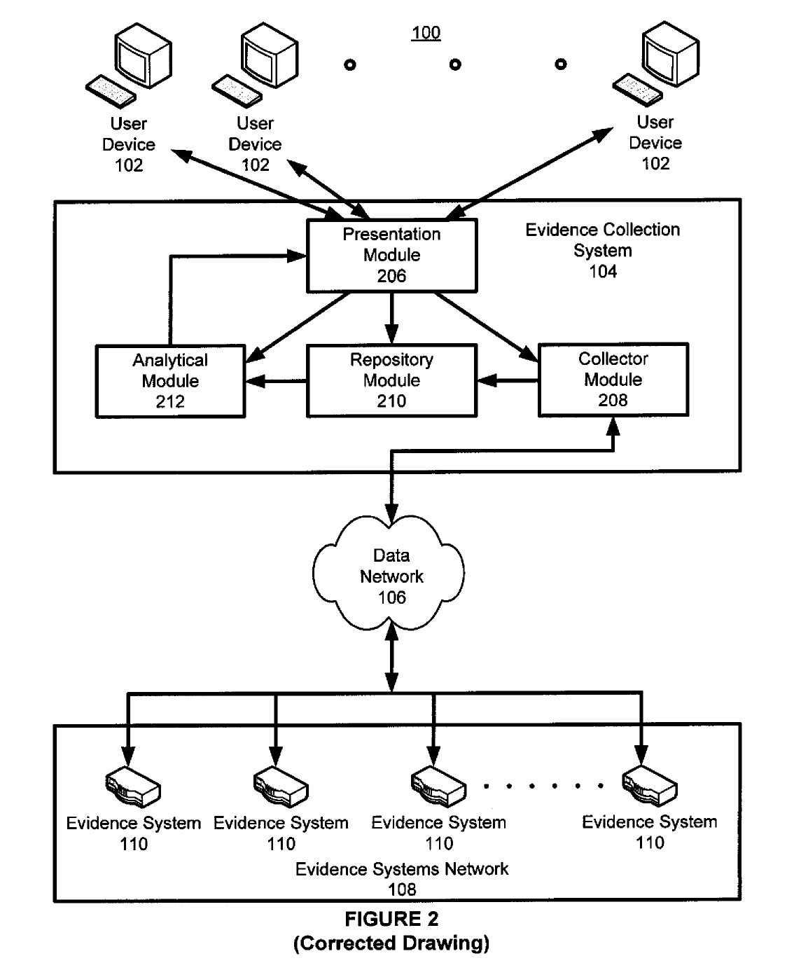

FIG. 2 illustrates a detailed exemplary system 100 for collecting evidentiary information from one or more evidence systems in accordance with an exemplary embodiment. The evidence collection system 104 may include a presentation module 206, a collector module 208, a repository module 210, and an analytical module 212. It is noted that the modules 206, 208, 210, and 212 are exemplary and the functions performed by one or more of the modules may be combined with that performed by other modules. The functions described herein as being performed by the modules 206, 208, 210, and 212 also may be separated and may be located and/or performed by other modules.

As shown in FIG. 2, the evidence collection system 104 may include the collector module 208 which may collect evidentiary information from the one or more evidence systems 110 in the evidence systems network 108 via the data network 106. The collector module 208 may preprocess the evidentiary information collected from the one or more evidence systems 110 in the evidence systems network 108 (e.g., filter, sort, format, aggregate). In an exemplary embodiment, the preprocessing of the evidentiary information provided by the collector module 208 may include filtering evidentiary information and eliminate undesired evidentiary information, sorting the evidentiary information in a chronological order, sorting the evidentiary information in accordance with the one or more evidence systems 110, formatting the evidentiary information into desired format (e.g., tables, spread sheets, timeline, linear representation), and/or data aggregation where evidentiary information may be gathered and expressed in a summary form.

The evidentiary information may be transferred from the collector module 208 to a repository module 210. The repository module 210 may store and/or manage the evidentiary information transferred from the collector module 208. An analytic module 212 may access the repository module 210 to obtain the evidentiary information needed to perform one or more processes and/or analyses. Finally, result of the one or more process and/or analyses may be transferred to the presentation module 206 and presented to a user via the one or more user devices 102. Also, the result of the one or more processes and/or analyses may be automatically and/or upon a request by a user, transferred to the presentation module 206 and presented to a user via one or more user devices 102 (e.g., display on a monitor).

Also, the presentation module 206 may provide an interface between one or more user devices 102 and the evidence collection system 104. The presentation module 206 may include a user interface, e.g., a graphical user interface, to receive one or more queries/requests from the user and to provide evidentiary information to the user via the one or more user devices 102. The presentation module 206 may provide a separate and/or a unified graphical user interface. In an exemplary embodiment, the presentation module 206 may provide a user with disparate display windows to view evidentiary information associated with each of the one or more evidence systems 110 e.g., closed-circuit television (CCTV) evidence system, security access control evidence system, network access control evidence system, and/or telephone evidence system. Also, the presentation module 206 may provide a user with a unified display window, for example but not limited to, a timeline and/or a linear representation of evidentiary information collected from the one or more evidence systems 110 without manually accessing each of the one or more evidence systems 110. Thus, a user may efficiently collect evidentiary information from the one or more evidence system 110 and present the collected evidentiary information in a chronological order.

In addition, the presentation module 206 may include an Application Programming Interface (API) to interact with the one or more user devices 102. The presentation module 206 may receive one or more queries/requests from the one or more user devices 102. In an exemplary embodiment, the one or more queries/requests may enable a user to input one or more characteristics associated with the business policy violation and/or the criminal violation. The one or more characteristics associated with the business policy violation and/or criminal violation may include, but not limited to, location, time, subjects, identities and/or other characteristics to facilitate the user to investigate a business policy violation and/or a criminal violation.

In response to receiving the one or more queries/requests from a user via the one or more user devices 102, the presentation module 206 may send one or more queries/requests (e.g., database queries) to the collector module 208, the repository module 210, and/or the analytical module 212. In response to one or more queries/requests, the analytical module 212 may (a) receive evidentiary information from the repository module 210 and/or the collector module 208 based at least in part on the one or more queries/requests, (b) process and/or analyze the evidentiary information, and (c) provide the process result and/or analysis result to the presentation module 206. The presentation module 206 may provide the process result and/or analysis results to the one or more user devices 102 for display. As a result, system 100 may allow a user to process and/or analyze evidentiary information from various evidence systems 110 at once.

Moreover, the presentation module 206 may include a toolbar module (not shown) for generating one or more toolbars. A user may utilize the toolbar to select the evidentiary information to be presented in the display window. In an exemplary embodiment, the evidentiary information collected from the one or more evidence systems 110 may be arranged in a chronological order, for example, a timeline. The toolbar may be provided along the timeline and the user may adjust a position (e.g., via a scroll bar) of the toolbar to various times along the timeline to display evidentiary information associated with the selected time. Additionally, in the event that presentation module 206 may provide disparate display windows for each of the one or more evidence systems 110. The toolbar module (not shown) may generate one or more toolbars for each disparate display windows and the user may adjust a position of the toolbar to display the desired evidentiary information. Thus, a user may utilize the toolbar to select the desired evidentiary information at various times in order to investigate a policy violation and/or a criminal violation.

The collector module 208 may interact with the one or more evidence systems 10 in the evidence systems network 108. Through these interactions, the evidentiary information captured and/or stored in each of the one or more evidence systems 10 may be collected. For example, the collector module 208 may sequentially and/or simultaneously collect evidentiary information from the one or more evidence systems 110. Evidentiary information collected from the one or more evidence systems 110 may include, but not limited to, time, date, computer, location, actions taken, uniform resource locator (URL) and/or other evidentiary information associated with one or more subjects (e.g., suspects, persons under investigation, persons of interest). The collector module 208 may use one or more methods to access the one or more evidence systems 110 via the data network 106. For example, the methods in which the collector module 208 may access the one or more evidence systems 110 may include, but not limited to, telecommunication network (TELNET), command line interface (CLI), simple network management protocol (SNMP), File Transfer Protocol (FTP), Secure Shell (SSH), structured query language (SQL) and/or other methods access and/or collecting evidentiary information from the one or more evidence systems 110.

The collector module 208 may provide the evidentiary information from each of the one or more evidence systems 110 to the repository module 210. For example, the collector module 208 may collect evidentiary information (e.g., audio data and/or video data) from a closed-circuit television (CCTV) evidence system. Also, the collector module 208 may collect evidentiary information from a security access control evidence system. The collector module 208 may collect time and/or identity of one or more subjects associated with a security badge scanning in/out of one or more locations. Further, the collector module 208 may collect evidentiary information from a network access control evidence system. The collector module 208 may collect a network access record and/or a computer access record of one or more subjects captured by the network access control evidence system. Furthermore, the collector module 208 may collect evidentiary information from a telephone evidence system. The collector module 208 may collect a phone record and/or a phone access record of one or more subjects captured by the telephone evidence system.

The repository module 210 may store and/or manage evidentiary information provided by the collector module 208. The repository module 210 may provide an interface, e.g., a uniform interface, for other modules within the system 100 and may write, read, and search evidentiary information in one or more repositories or databases (not shown). The repository module 210 may also perform other functions, such as, but not limited to, concurrent access, backup and archive functions. Also, due to limited amount of storing space the repository module 210 may compress, store, transfer and/or discard the evidentiary information stored within, after a period of time, e.g., a month. The repository module 210 may provide evidentiary information to the analytical module 212.

The analytical module 212 may retrieve evidentiary information from the repository module 210 and process such evidentiary information. The analytical module 212 may further include a plurality of sub-analytical modules (not shown) to perform processing of the evidentiary information. In an exemplary embodiment, a time component may be associated with the evidentiary information collected from each of the one or more evidence systems 110. The analytical module 212 may arrange the evidentiary information collected from each of the one or more evidence systems 110 in a chronological order based at least in part on a time element of the evidentiary information. For example, the analytical module 212 may arrange the evidentiary information collected from each of the one or more evidence systems 110 on a single timeline to determine locations and/or activities of one or more subjects at various times. Also, the analytical module 212 may arrange the evidentiary information based at least in part on a location. For example, the analytical module 212 may arrange the evidentiary information at a location (e.g., entrances/exits of a building) collected from each of the one or more evidence systems 110 in a chronological order. Further, the analytical module 212 may arrange the evidentiary information based at least in part on one or more desired times and/or one or more time periods. For example, the analytical module 212 may arrange the evidentiary information at one or more desired times (e.g., at 8 a.m., at noon, and at 5 p.m.) collected from each of the one or more evidence systems 110 in a chronological order. Also, the analytical module 212 may arrange the evidentiary information for one or more time periods (e.g., 7 a.m. to 10 a.m., 2 p.m. to 3 p.m., and 6 p.m. to 8 p.m.) collected from each of the one or more evidence systems 110 in a chronological order.

Also, the analytical module 212 may retrieve evidentiary information from the repository module 210 and analyze such evidentiary information. The analytical module 212 may further include a plurality of sub-analytical modules (not shown) to perform various types of data analyses. The analytical module 212 may perform various analyses, such as, but not limited to, time series analysis, forensic analysis, and/or pattern matching analysis. For example, using the one or more user devices 102, a user may select various types of data analysis to be performed. A user may select a time series data analysis where evidentiary information collected from one or more evidence systems 110 at an earlier time may be compared with evidentiary information collected from the one or more evidence systems 110 at a later time. Also, a user may select forensic data analysis where the evidentiary information collected in the past, from the one or more evidence systems 110. Further, a user may select pattern matching analysis where patterns associated with the evidentiary information collected in the past from the one or more evidence systems 110 may be matched with more recent evidentiary information collected from the one or more evidence systems 110. The analytical module 212 may summarize and/or aggregate evidentiary information retrieved from the repository module 210 to provide a complete report (e.g., in a timeline) of a business policy violation and/or a criminal violation from the one or more interfaces associated with the one or more evidence systems 110.

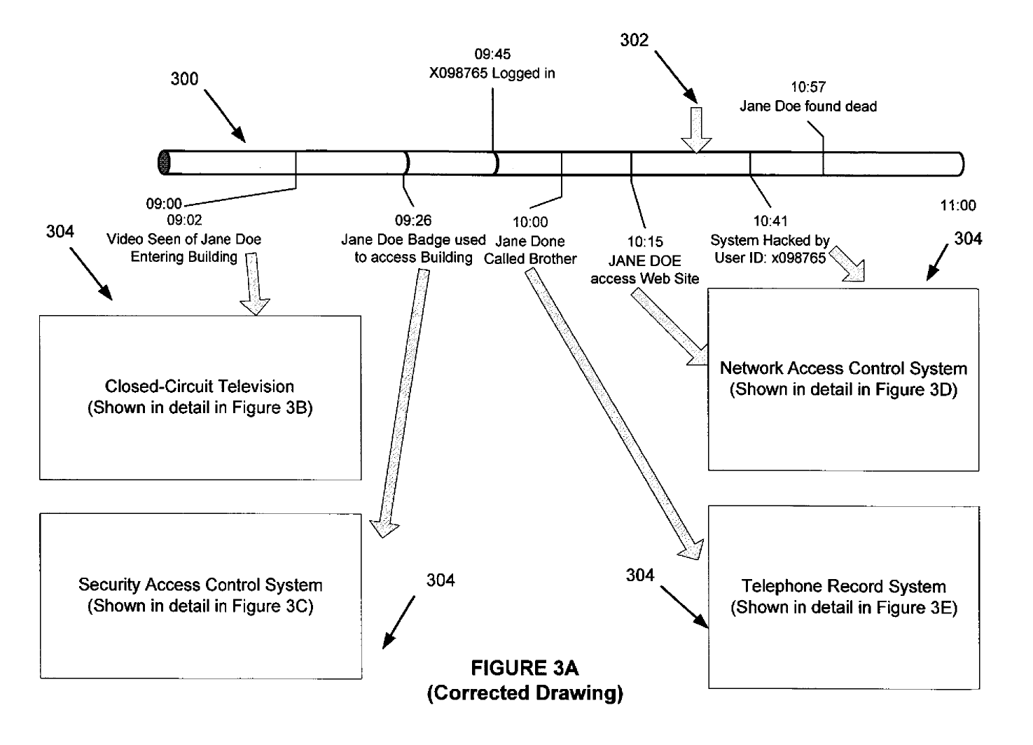

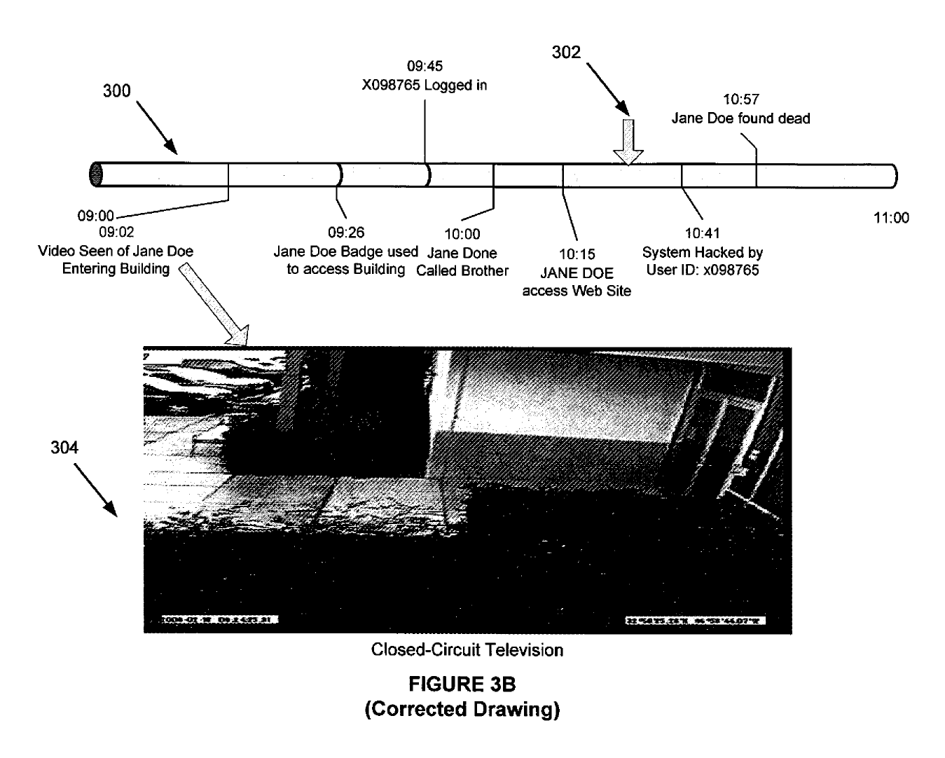

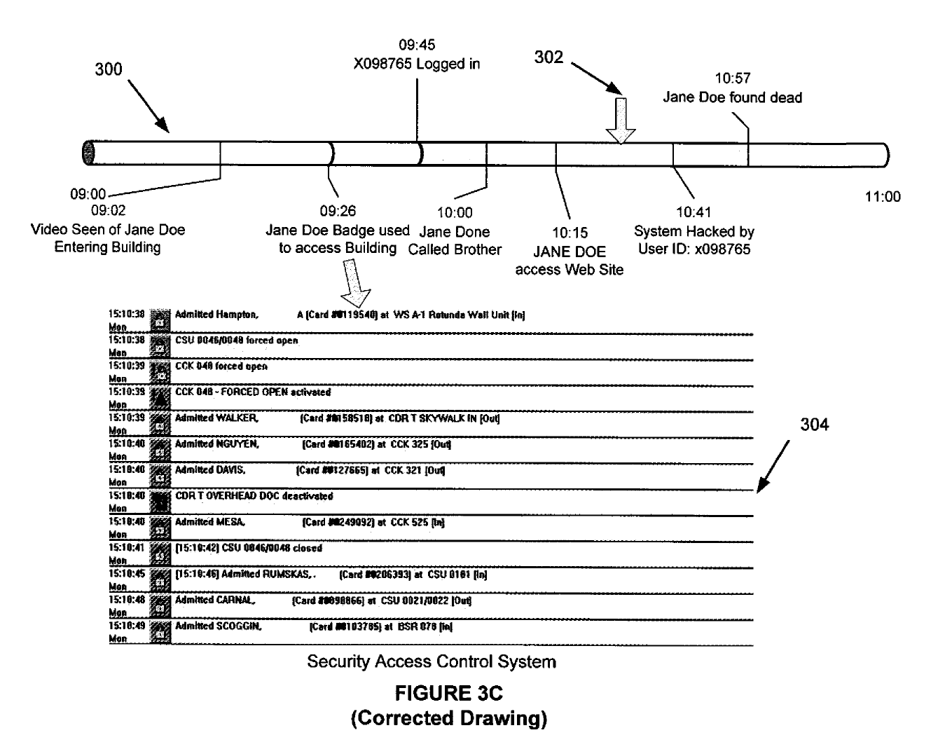

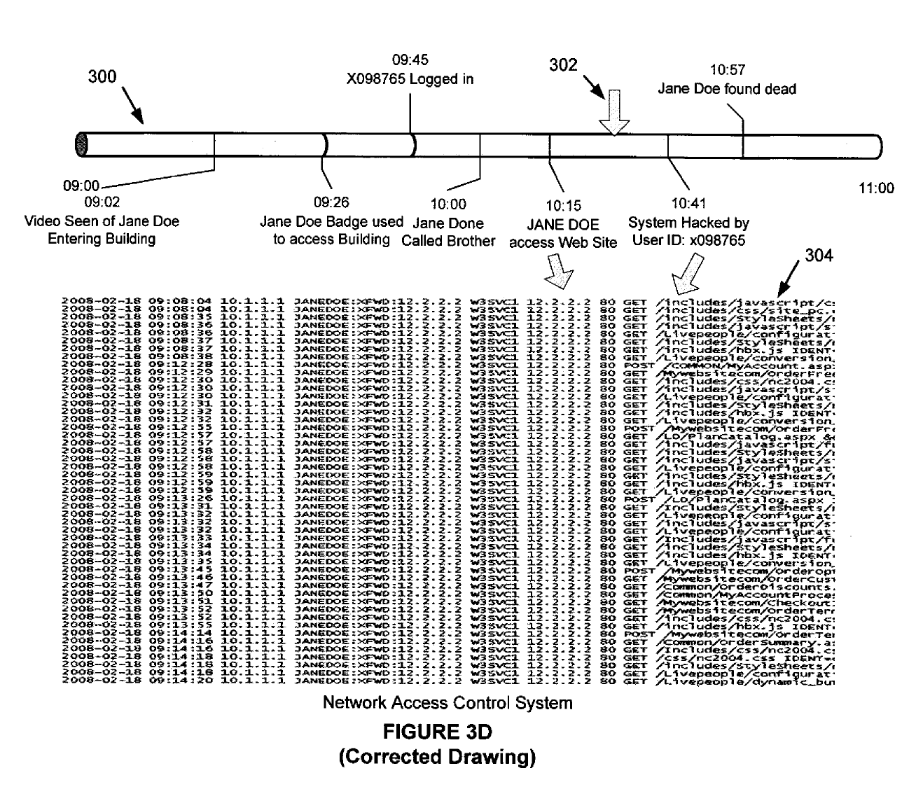

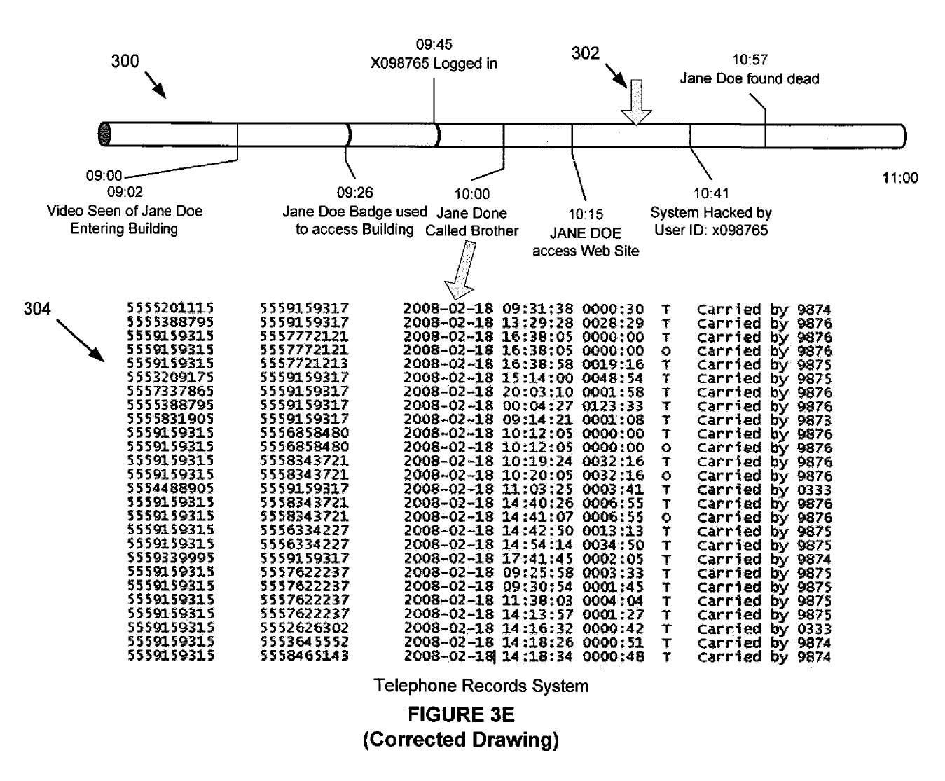

FIGS. 3A-3E illustrate an exemplary timeline provided by a data and evidence collection system in accordance with an exemplary embodiment. In an exemplary embodiment, a subject named Jane Doe may have been murdered at 10:57 a.m. and a user (e.g., an investigator and/or a detective) may investigate Jane Doe's activities before the murder. The user may input one or more queries/requests to the evidence collection system 104. In an exemplary embodiment, the user may utilize the one or more user devices 102 to submit one or more queries/requests for evidentiary information associated with Jane Doe. The one or more queries/requests submitted by the user may include a location (e.g., a crime scene), a time period (e.g., two hours from 9 a.m. to 11 a.m.), and a subject's identity (e.g., Jane Doe). Upon receiving the one or more queries/requests, the evidence collection system 104 may collect evidentiary information associated with Jane Doe from one or more evidence systems 110 based at least in part on the one or more queries/requests.

The evidence collection system 104 may construct a time line 300 based at least in part on the evidentiary information collected from the one or more evidence systems 110 (e.g., shown in FIGS. 3A-3E). In an exemplary embodiment, the time line 300 may include evidentiary information from the one or more evidence systems 110. Also, the time line 300 may include a time toolbar 302 to enable the user to view the evidentiary information collected from the one or more evidence systems 110 at various times. For example, the user may adjust a position of the time toolbar 302 along the time line 300 to view evidentiary information corresponding to the selected time. Also, the user may click on a position along the time line 300 to view evidentiary information corresponding to the selected time. For example, the time line 300 may include one or more display windows 304 to present the evidentiary information collected from the one or more evidence systems 10. For example, each of the one or more display windows 304 may present evidentiary information corresponding to each of the one or more evidence systems 110 (e.g., FIGS. 3B-3E). Moreover, the one or more display windows 304 may include a time toolbar (not shown) to enable the user to view the evidentiary information collected from each of the evidence systems 110 at a selected time. In an exemplary embodiment, the user may adjust a position of the time toolbar (not shown) to view the evidentiary information presented in each of the one or more display windows 304.

As illustrated in FIGS. 3A and 3B, at 9:02 a.m., Jane Doe may enter a building (e.g., a work place) as shown by a closed-circuit television (CCTV) evidence system. The closed-circuit television (CCTV) evidence system may present video data and/or audio data at 9:02 a.m. to the user. Also, at 9:26 a.m., a security access control evidence system (e.g., FIG. 3C) may present evidentiary information that Jane Doe entered (e.g., scanned in using a security badge) into the building. The security access control evidence system may present scanned in/out data of one or more subjects at 9:26 a.m. Subsequently, at 9:45 a.m., a network access control evidence system (e.g., FIG. 3D) may present evidentiary information that Jane Doe logged into a network (e.g., workplace Intranet and/or workplace Internet) and/or a device (e.g., a work station and/or a computer located on the 4^{th} floor). The network access control evidence system may present log in/out data, computer usage data, Internet activities data, and/or other network data associated with one or more subjects. At 10:00 a.m., a telephone evidence system (e.g., FIG. 3E) may present evidentiary information to demonstrate that Jane Doe made a telephone call to one or more telephone numbers. For example, the user may determined a number of telephone calls made and/or whom Jane Doe contacted (e.g., her brother) based at least in part on the telephone numbers presented by the telephone evidence system. At 10:15 a.m., the network access control evidence system (e.g., FIG. 3D) may present evidentiary information that Jane Doe visited one or more websites. As recited above, the network access control evidence system may record one or more websites visited by Jane Doe, and the user may gather information associated with Jane Doe based at least in part on the visited websites. At 10:41 a.m., the network access control evidence system (e.g., FIG. 3D) may present evidentiary information that a secured network was hacked into by an unauthorized subject. The network access control evidence system may identify a location of the hacking, an identity of the hacker (e.g., user ID, or network access ID), time of the hacking, activities of the hacker in the secured network and/or other information associated with hacking of the secured network. In an exemplary embodiment, the user may request the analytical module 212 to perform a pattern matching analysis in order to determine whether a correlation existed between Jane Doe visiting one or more websites (e.g., at 10:15 a.m.) and the hacking of the secured network (e.g., at 10:41 a.m.). Finally, at 10:57 a.m., Jane Doe was found dead. Therefore, the time line 300 may provide the user with a comprehensive view of the evidentiary information collected from the one or more evidence systems 110 associated with Jane Doe two hours prior to her death.

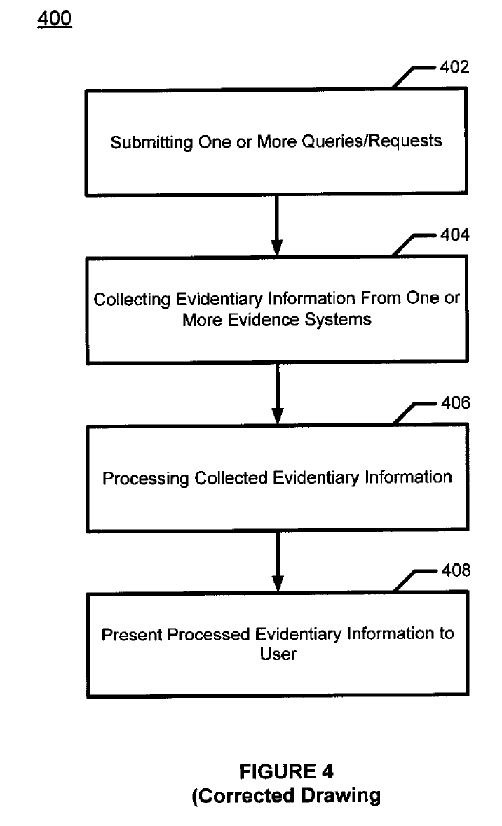

FIG. 4 depicts a flow diagram of a method for collecting data and evidence in accordance with an exemplary embodiment. The exemplary method is provided by way of example, as there are a variety of ways to carry out methods disclosed herein. The method 400 shown in FIG. 4 may be executed or otherwise performed by one or a combination of various systems. The method 400 described below are carried out by the system 100 shown in FIGS. 1 and 2 by way of example, and various elements of the system 100 are referenced in explaining the example methods of FIG. 4. Each block shown in FIG. 4 represents one or more processes, methods, or subroutines carried in the exemplary method 4. A computer readable media comprising code to perform the acts of the method 400 may also be provided. Referring to FIG. 4, the exemplary method 400 may begin at block 402.

At block 402, a user may submit one or more queries/requests to collect evidentiary information associated with a business policy violation and/or a criminal violation. For example, the user may utilize a user device 102 to input one or more characteristics associated with the business policy violation and/or the criminal violation for the one or more queries/requests. The one or more characteristics associated with the business policy violation and/or the criminal violation may include, but not limited to, location, time, subjects, identities and/or other characteristics to facilitate the user to investigate the business policy violation and/or the criminal violation. The one or more queries/requests may be provided to the evidence collection system 104. The method may continue to block 404.

At block 404, the collector module 208 of the evidence collection system 104 may collect evidentiary information from one or more evidence systems 110. In an exemplary embodiment, the collector module 208 may collect evidentiary information from the one or more evidence systems 110 based at least in part on the one or more queries/requests. For example, the collector module 208 may access a closed-circuit television (CCTV) evidence system, a security access control evidence system, a network access control evidence system, telephone evidence system, and/or other evidence systems to collect evidentiary information based at least in part on the one or more queries/requests. The evidentiary information collected may be stored in the repository module 210 of the evidence collection system 104. The method may continue to block 406.

At block 406, an analytical module 212 may process the collected evidentiary information. For example, the analytical module 212 may arrange the evidentiary information collected from each of the one or more evidence systems 110 in a chronological order based at least in part on the one or more queries/requests. For example, the analytical module 212 may arrange the evidentiary information in a chronological order (e.g., a time line) based at least in part on a location, one or more desired time and/or one or more time periods. Also, the analytical module 212 may perform various analyses, such as, but not limited to, time series analysis, forensic analysis, and/or pattern matching analysts. The method may continue to block 408.

At block 408, the processed and/or analyzed evidentiary information may be presented to the user via the user device 102. In an exemplary embodiment, the processed evidentiary information may be presented to the user in a time line having one or more display windows to display evidentiary information collected from each of the evidence systems 110. The user may adjust one or more tool bars to display evidentiary information associated with a selected time to enable the user to investigate the business policy violation and/or the criminal violation.

In the preceding specification, various embodiments have been described with reference to the accompanying drawings. It will, however, be evident that various modifications and changes may be made thereto, and additional embodiments may be implemented, without departing from the broader scope of the exemplary embodiments as set forth in the claims that follow. The specification and drawings are accordingly to be regarded in an illustrative rather than restrictive sense.

1. A system comprising:
a collector module configured to collect evidentiary information associated with one or more evidence systems within an evidence systems network;
a repository module configured to store the evidentiary information associated with the one or more evidence systems;
an analytical module configured to process the evidentiary information associated with the one or more evidence systems in a chronological order; and
a presentation module configured to output the processed evidentiary information associated with the one or more evidence systems in the chronological order.

2. The system of claim 1, wherein the one or more evidence systems associated with the evidence systems network comprise at least one of a closed-circuit television (CCTV) evidence system, a security access control evidence system, a network access control evidence system, and a telephone evidence system.

3. The system of claim 1, wherein the one or more evidence systems associated with the evidence systems network is configured to collect at least one of audio evidentiary information, visual evidentiary information, and log evidentiary information.

4. The system of claim 1, wherein process the evidentiary information associated with the one or more evidence systems in a chronological order further comprises arranging the evidentiary information associated with the one or more evidence system in a time line.

5. The system of claim 1, wherein the presentation module is further configured to present one or more display windows associated with each one of the one or more evidence systems associated with the evidence systems network.

6. The system of claim 1, wherein the collector module is further configured to process the evidentiary information associated with the one or more evidence systems.

7. The system of claim 6, wherein processing the evidentiary information associated with the one or more evidence systems comprises at least one of filtering, formatting and aggregating the evidentiary information.

8. The system of claim 1, wherein the analytical module is further configured to perform at least one of data mining analysis, pattern matching analysis, time series analysis, correlative analysis, forensics analysis, and exploratory analysis.

9. The system of claim 1, wherein the presentation module is further configured to present an adjustable time toolbar to select the evidentiary information associated with the one or more evidence systems based at least in part on the chronological order.

10. The system of claim 5, wherein the presentation module is further configured to present an adjustable time toolbar associated with the one or more display windows to select the evidentiary information from each of the one or more evidence systems associated with the evidence systems network.

11. The system of claim 1, wherein the presentation module is further configured to receive one or more inputs from a user.

12. The system of claim 1, further comprises one or more user devices to display the result of the processed evidentiary information associated with the one or more evidence systems in a chronological order.

13. A method, comprising:
collecting evidentiary information from the one or more evidence systems associated with the evidence systems network;
storing the evidentiary information collected from the one or more evidence systems associated with the evidence systems network;
processing the evidentiary information collected from the one or more evidence systems associated with the evidence systems network in a chronological order;
outputting result of the processed evidentiary information collected from the one or more evidence systems associated with the evidence systems network.

14. The method of claim 13, wherein collecting the evidentiary information from the one or more evidence systems associated with the evidence systems network further comprises collecting the evidentiary information from the one or more evidence systems based at least in part on user input.

15. The method of claim 13, further comprises the one or more evidence systems associated with the evidence systems network collecting at least one of audio evidentiary information, visual evidentiary information, and log evidentiary information.

16. The method of claim 13, further comprises processing the evidentiary information collected from the one or more evidence systems associated with the evidence systems network in a timeline.

17. The method of claim 13, wherein processing the evidentiary information collected from the one or more evidence systems associated with the evidence systems network further comprises at least one of the filtering, formatting and aggregating the evidentiary information.

18. The method of claim 13, further comprises analyzing the evidentiary information collected from the one or more evidence systems associated with the evidence systems network by performing at least one of data mining analysis, pattern matching analysis, time series analysis, correlative analysis, forensics analysis, and exploratory analysis.

19. The method of claim 13, further comprises presenting the evidentiary information collected from the one or more evidence systems associated with the evidence systems network in one or more display windows

20. The method of claim 19, selecting the evidentiary information collected from the one or more evidence systems associated with the evidence systems network via a time toolbar.

21. A computer readable media comprising code to perform the acts of the method of claim 13.
